(19) United States
(12) Patent Application Publication
(10) Pub. No.: US 2009/0055513 A1
(43) Pub. Date: Feb. 26, 2009

(54) METHOD AND SYSTEM FOR COMMUNICATING CARPOOL INFORMATION

(75) Inventors: Eric Lee Berry, Monrovia, CA (US); Eva Brigitta Brorsdotter Ingvarson, Los Angeles, CA (US); Bo Kwon, Santa Monica, CA (US); Jessica Hope Landy, Los Angeles, CA (US); Allan Siping Lim, Glendale, CA (US); Thomas John Louis Thomsen, Los Angeles, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Evite LLC, West Hollywood, CA (US)

(21) Appl. No.: 11/844,724

(22) Filed: Aug. 24, 2007

(51) Int. Cl. G06F 15/16

(52) U.S. Cl. 709/219

(57) ABSTRACT

The invention provides a communications system comprising a receiving module for receiving the carpool information from a plurality of user computer systems over a network, a carpool module for collecting carpool information received by the receiving module from a plurality of user computer systems, storing the carpool information at a server computer system, the carpool information being for a plurality of users corresponding to carpool information collected from the plurality of user computer systems at a server computer system, and permitting access to the carpool information collected from the plurality of user computer systems on the server computer system from each one of the user computer systems, the carpool information being associated with the event.

### BACKGROUND OF THE INVENTION

1). Field of the Invention

This invention relates generally to a network-based communications system and method, and aspects of the invention relate to the creation of events and invitations, associating hotel and other location information, and collecting and communicating carpool information.

2). Discussion of Related Art

Networks such as the Internet can be used to transmit a signal from a first computer system to a second computer system over the network, and to subsequently receive the signal at the second computer system. Such a signal can include an email, a web page, etc.

The Internet has become particularly useful for creating events and sending invitations, for example at www.evite.com. An event host can choose from a number of different designs for an event and an associated invitation, add text, and then transmit email invitations to email addresses of a plurality of guests. An guest can then select a link in the email to open a browser, view the invitation and respond to the invitation. The event host and guests can view an event management page that shows the responses of other guests.

### SUMMARY OF THE INVENTION

The invention provides a communications system comprising a receiving module for receiving the carpool information from a plurality of user computer systems over a network, a carpool module for collecting carpool information received by the receiving module from a plurality of user computer systems, storing the carpool information at a server computer system, the carpool information being for a plurality of users corresponding to carpool information collected from the plurality of user computer systems at a server computer system, and permitting access to the carpool information collected from the plurality of user computer systems on the server computer system from each one of the user computer systems, the carpool information being associated with the event.

The communications system may further comprise an event server computer system, an event creation module on the event server computer system for permitting the creation of an event from an event host computer system over the network, and a storing module on the event server computer system for storing the event on the event server computer system.

The communications system may further comprise a transmissions module on the event server computer system for transmitting an invitation message over the network to each one of a plurality of guest user computer systems.

The invitation message may be utilized to access an invitation associated with the event on the event server computer system, the carpool information being associated with the invitation.

The communications system may further comprise a module on the event server computer system for receiving a response to the invitation on the event server computer system using one of the guest user computer systems.

The communications system may further comprise a view displaying responses using the event host user computer system.

The communications system may further comprise carpool information that may be accessed from each one of the user computer systems and may include an address.

The communications system may further comprise a view that may include a map and a plurality of markers, each corresponding to a respective one of the addresses.

The view may include the addresses.

The carpool information that may be accessed from each one of the user computer systems may include vehicle information.

The carpool information that may be accessed from each one of the user computer systems may include a seating preference.

The carpool information that may be accessed from each one of the user computer systems may include a music preference.

The carpool module may allow for utilizing a first of the user computer systems corresponding to carpool information for a first user to select a second user corresponding to carpool information received from a second user computer system, and utilizing the first computer system to make an offer for carpool transportation.

The carpool module may allow for utilizing the second computer system to accept the offer for carpool transportation.

The carpool module may allow for recording the acceptance of the offer for carpool transportation at the server computer system.

The communications system may further comprise a view that indicates that a third user corresponding to carpool information received from a third user of the user computer systems requires transportation based on recorded acceptances for carpool transportation, the view indicating that the first and second users do not require transportation based on the recorded acceptance from the second user computer system.

The invention provides a communications method comprising receiving carpool information over a network from a plurality of user computer systems, collecting the carpool information received from the plurality of user computer systems, storing the carpool information at a server computer system, the carpool information being for a plurality of users corresponding to carpool information collected from the plurality of user computer systems at a server computer system, and permitting access to the carpool information collected from the plurality of user computer systems on the server computer system from each one of the user computer systems.

The method may further comprise permitting the creation of an event from an event host computer system over the network, storing the event on an event server computer system, and associating the carpool information with the event.

The method may further comprise transmitting an invitation message over the network to each one of a plurality of guest user computer systems.

The method may further comprise associating the carpool information with an invitation, and utilizing the invitation message to access the invitation associated with the event on the event server computer system.

The method may further comprise responding to the invitation on the event server computer system using one of the guest user computer systems.

The method may further comprise opening a view displaying responses using the event host user computer system.

The method may further comprise opening a view displaying responses using the event host user computer system.

The carpool information that may be accessed from each one of the user computer systems may include an address.

The method may further comprise displaying a view that may include a map and a plurality of markers, each corresponding to a respective one of the addresses.

The view may include the addresses.

The carpool information that may be accessed from each one of the user computer systems may include vehicle information.

The carpool information that may be accessed from each one of the user computer systems may include a seating preference.

The carpool information that may be accessed from each one of the user computer systems may include a music preference.

The method may further comprise utilizing a first of the user computer systems corresponding to carpool information for a first user to select a second user corresponding to carpool information received from a second user computer system, and utilizing the first computer system to make an offer for carpool transportation.

The method may further comprise utilizing the second computer system to accept the offer for carpool transportation.

The method may further comprise recording the acceptance of the offer for carpool transportation at the server computer system.

The method may further comprise displaying a view that indicates that a third user corresponding to carpool information received from a third user of the user computer systems requires transportation based on recorded acceptances for carpool transportation.

The method may further comprise indicating in the view that the first and second users do not require transportation based on the recorded acceptance from the second user computer system.

The invention also provides a computer-readable medium having stored thereon a set of instructions which, when executed by a computer, may at least assist in carrying out a communications method comprising receiving carpool information over a network from a plurality of user computer systems, collecting the carpool information received from the plurality of user computer systems, storing the carpool information at a server computer system, the carpool information being for a plurality of users corresponding to carpool information collected from the plurality of user computer systems at a server computer system, and permitting access to the carpool information collected from the plurality of user computer systems on the server computer system from each one of the user computer systems.

In the computer-readable medium, the method may further comprise permitting the creation of an event from an event host computer system over the network, storing the event on an event server computer system, and associating the carpool information with the event.

In the computer-readable medium, the method may further comprise transmitting an invitation message over the network to each one of a plurality of guest user computer systems.

In the computer-readable medium, the method may further comprise associating the carpool information with an invitation, wherein the invitation message may be utilized to access an invitation associated with the event on the event server computer system.

In the computer-readable medium, the method may further comprise responding to the invitation on the event server computer system using one of the guest user computer systems.

In the computer-readable medium, the method may further comprise opening a view displaying responses using the event host user computer system.

In the computer-readable medium, the carpool information that may be accessed from each one of the user computer systems may include an address.

In the computer-readable medium, the method may further comprise displaying a view that may include a map and a plurality of markers, each corresponding to a respective one of the addresses.

In the computer-readable medium, the view may include the addresses.

In the computer-readable medium, the carpool information that may be accessed from each one of the user computer systems may include vehicle information.

In the computer-readable medium, the carpool information that may be accessed from each one of the user computer systems may include a seating preference.

In the computer-readable medium, the carpool information that may be accessed from each one of the user computer systems may include a music preference.

In the computer-readable medium, the method may further comprise utilizing a first of the user computer systems corresponding to carpool information for a first user to select a second user corresponding to carpool information received from a second user computer system, and utilizing the first computer system to make an offer for carpool transportation.

In the computer-readable medium, the method may further comprise utilizing the second computer system to accept the offer for carpool transportation.

In the computer-readable medium, the method may further comprise recording the acceptance of the offer for carpool transportation at the server computer system.

In the computer-readable medium, the method may further comprise displaying a view that indicates that a third user corresponding to carpool information received from a third user of the user computer systems requires transportation based on recorded acceptances for carpool transportation.

In the computer-readable medium, the method may further comprise indicating in the view that the first and second users do not require transportation based on the recorded acceptance from the second user computer system.

### BRIEF DESCRIPTION OF THE DRAWINGS

The invention is further described by way of example with reference to the accompanying drawings, wherein:

FIG. 1 is a block diagram of a communication system, according to an embodiment of the invention;

FIG. 2 is a block diagram of an event server computer system forming part of the communications system;

FIGS. 3 to 11 are views that are displayed on a browser at an event host computer system, showing the creation of an event and related hotel information;

FIGS. 12 and 13 are views showing how carpool information is collected from an event host computer system;

FIG. 14 shows an email that is created for purposes of inviting guests;

FIGS. 15 and 16 are views that are displayed at an guest user computer system showing how an guest responds to an invitation and optionally selects to view carpool information;

FIG. 16A shows an event management page;

FIG. 17 is an email that is sent to an guest user computer system upon selection of an guest to have data included in carpool information;

FIGS. 18 to 20 are views that are displayed at the guest user computer system for purposes of collecting carpool information;

FIGS. 21 to 23 are views that are displayed at an event host computer system to illustrate how different users can accept or decline carpool requests and further communicate with one another;

FIG. 24 is a flowchart illustrating how an event is created;

FIG. 25 is a flowchart illustrating how location information is associated with an event;

FIG. 26 is a flowchart illustrating how carpool information is created and communicated; and

FIG. 27 is a diagrammatic representation of a machine in the exemplary form of a computer within which a set of instructions may be executed.

### DETAILED DESCRIPTION OF THE INVENTION

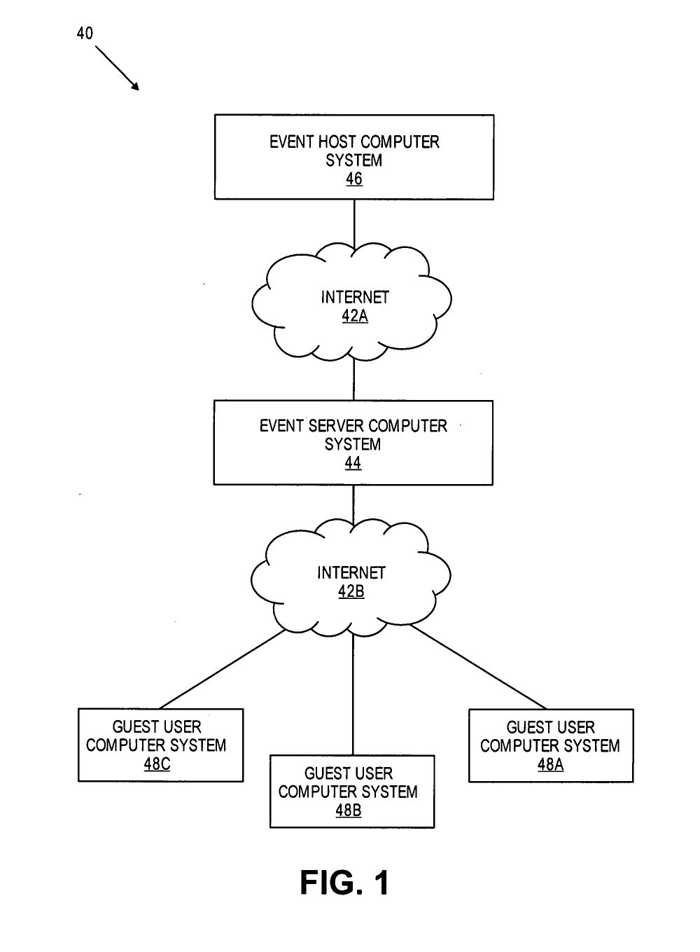

FIG. 1 of the accompanying drawings illustrates a communications system 40, according to an embodiment of the invention, which includes a network in the form of the Internet 42A and 42B, an event server computer system 44, an event host computer system 46, and a plurality of guest user computer systems 48A, 48B, and 48C.

The event host computer system 46 is connected over the Internet 42A to the event server computer system 44. The guest user computer systems 48A, 48B, and 48C are connected over the Internet 42B to the event server computer system 44. The Internet 42A and 42B are representative of a network. Although the Internet 42A and 42B are shown as a separate component, it should be understood that both components may in fact be the same network; the Internet 42A and 42B are shown as separate components to illustrate that the event host computer system 46 and the guest user computer systems 48A, 48B, and 48C communicate with one another via the event server computer system 44.

It should also be understood that the event server computer system 44 has the ability to communicate and store data from a plurality of event host computer systems in addition to the event host computer system 46 shown in FIG. 1. In order not to obscure the invention, event host computer systems other than the event host computer system 46 are not shown in FIG. 1 and are not described in detail herein. Any one of the guest user computer systems 48A, 48B, and 48C may also act as an event host computer system.

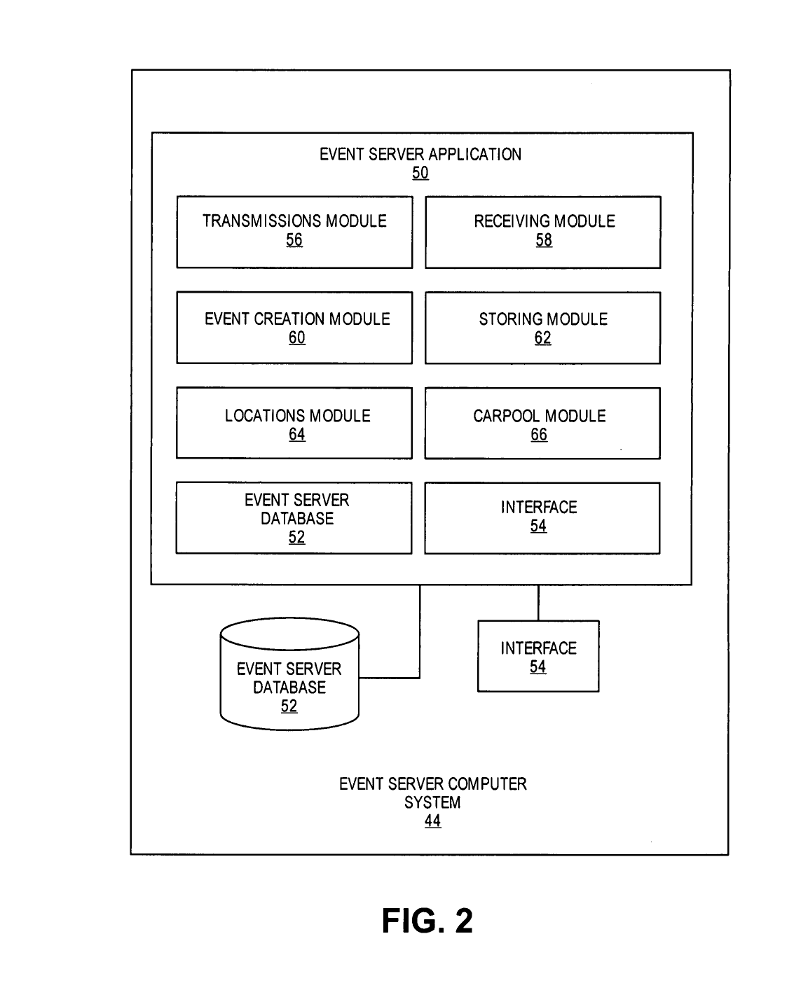

FIG. 2 illustrates components of the event server computer system 44, including an event server application 50, an event server database 52, and an interface 54. The event server application 50 includes a transmissions module 56, a receiving module 58, an event creation module 60, a storing module 62, a locations module 64, a carpool module 66, etc. The modules 56, 58, 60, 62, 64, and 66 are in communication with one another. The event server application 50 is connected to the interface 54 and to the event server database 52. The interface 54 provides views that can be uploaded from the guest user computer systems 48A, 48B, and 48C and from the event host computer system 46 in FIG. 1. The receiving module 58 receives requests from the event host computer system 46 and from the guest user computer systems 48A, 48B, and 48C. The transmissions module 56 transmits views of the interface 54 to the event host computer system 46 and the guest user computer systems 48A, 48B, and 48C. The storing module 62 stores and retrieves data from the event server database 52.

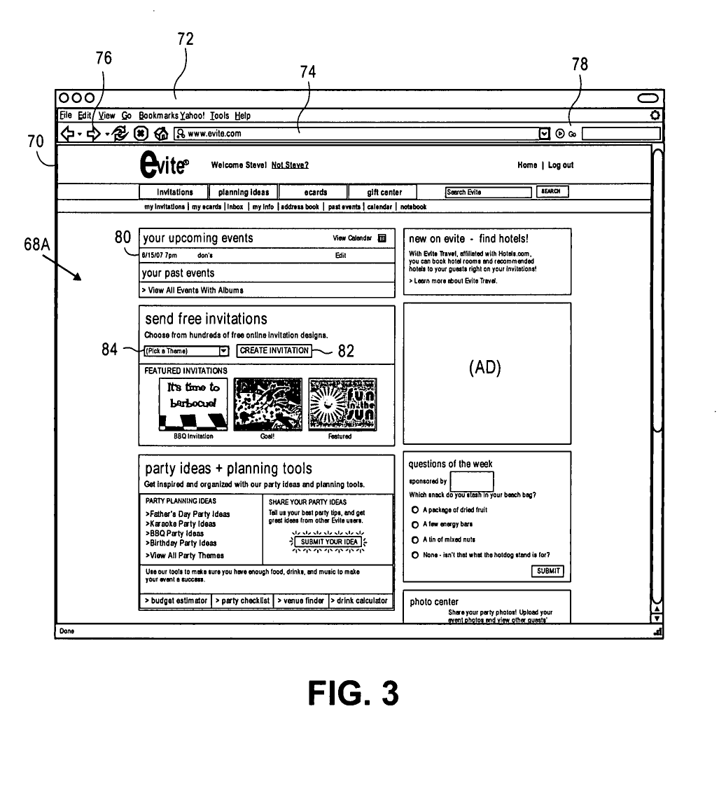

FIG. 3 illustrates a view 68A of the interface 54 that appears in a window 70 of a browser 72 on the event host computer system 46. The browser 72, in addition to the window 70, includes an address bar 74 and a plurality of navigation buttons 76. An event host at the event host computer system 46 enters a URL address (in the present example, www.evite.com) in the address bar 74 and then either selects a “go” button 78 of the browser 72 or depresses an “enter” key on a keyboard, causing transmission of a signal from the event host computer system 46 over the Internet 42A to the event server computer system 44. The receiving module 58 of the event server application 50 receives the signal. In the present example, the signal includes a request for the view 68A of the interface 54. The transmissions module 56 then transmits the view 68A from the event server computer 44 over the Internet 42A to the event host computer system 46. The event host computer system 46 then displays the view 68A in the window 70. The event server computer system 44, having recognized the address of the event host computer system 46, has extracted related data for the event host computer system 46 from the event server database 52 and has automatically logged the event host computer system 46 in (as indicated by “Welcome, Steve!”).

Each transaction between the event host computer system 46 and the event server computer system 44 is by way of a respective signal. Details of every signal and every request or data contained in the signal are similar to the signals that are described with reference to FIG. 3 and are thus not described in further detail herein.

The view 68A includes a list of events 80 under the heading “your upcoming events,” listing only a single event at that stage. The view 68A also has an event creation button 82 labeled “create invitation” and a theme selector 84 next to the event creation button 82.

The event host at the event host computer system 46 uses a cursor and the theme selector 84 to select a theme (in the present example, “housewarming”) and then selects the event creation button 82.

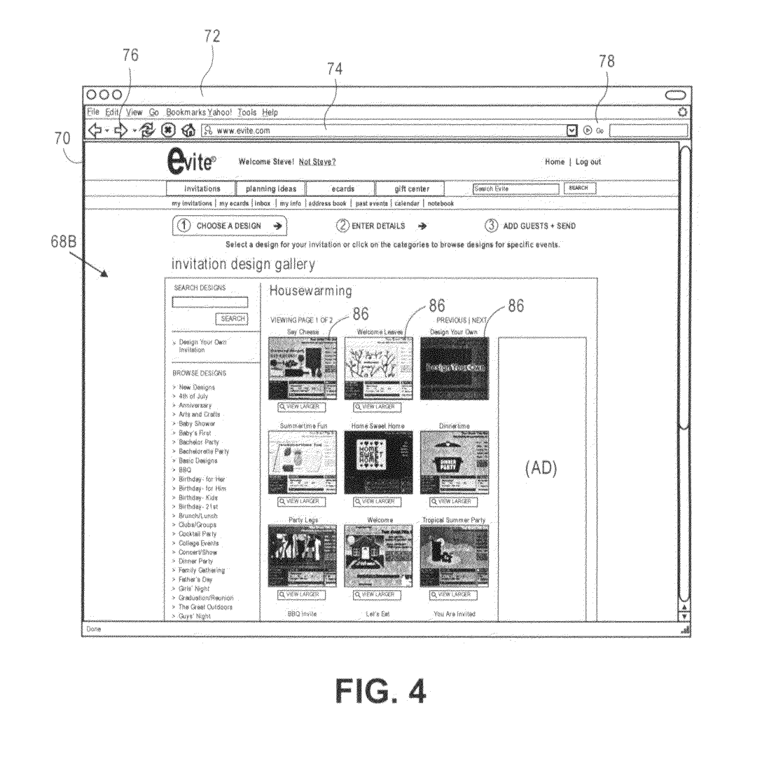

FIG. 4 shows a view 68B that appears after the event host selects the event creation button 82 in the view 68A of FIG. 3. The view 68B of FIG. 4 replaces the view 68A of FIG. 3. The view 68B allows for the event host to select a design from a plurality of designs 86. The designs 86 that are shown in the view 68B depend from and are different for every theme that is selected in the view 68A of FIG. 3.

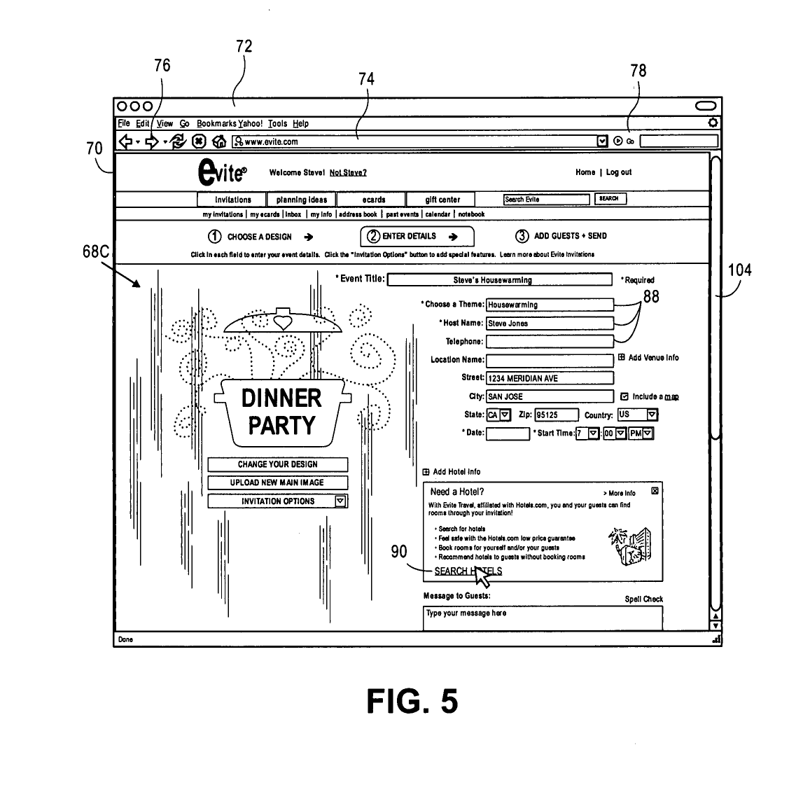

FIG. 5 is a view 68C that replaces the view 68B of FIG. 4 after the event host selects one of the designs 86 in the view 68B. The view 68C includes fields 88 for entering details regarding the event. The fields 88 include a field for entering a street address, a field for entering a city, a field for entering a state, a field for entering a zip code, and a field for entering a country, all of which are required for purposes of identifying the exact address of the event. The exact address of the event is also information that may be required by guests when deciding to carpool and will be displayed on a carpool map with a marker. The fields 88 also include a field for the date and the start time of the event.

The views 68A, 68B, and 68C of FIGS. 3, 4, and 5 are generated by the transmissions module 56, receiving module 58, and the event creation module 60 in FIG. 2. The view 68C of FIG. 5 also includes a link 90 for invoking the locations module 64 in FIG. 2. The link 90 is labeled “search hotels” and the locations module 64 is used to find and associate hotels with an event. It should, however, be understood that the locations module 64 may be used to associate locations other than hotels with an event.

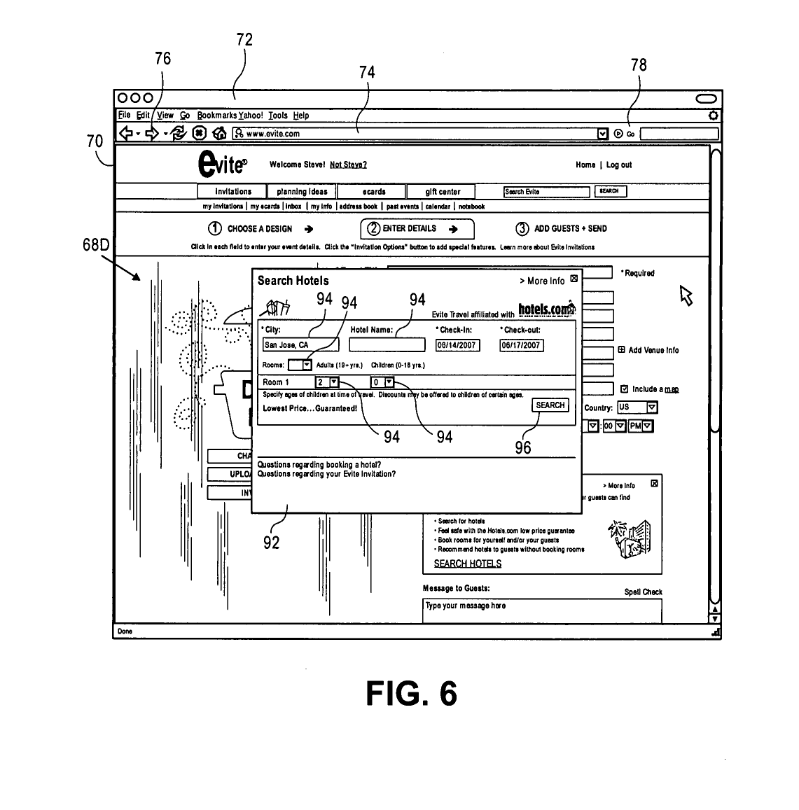

FIG. 6 shows a view 68D that replaces the view 68C of FIG. 5 after the event host selects the link 90 in the view 68C of FIG. 5. The view 68D of FIG. 6 is the same as the view 68C of FIG. 5, but includes a static overlay window 92 that can be used for searching hotels on an affiliated site. The window 92 includes fields 94 for a city, a hotel name, a check-in date, a check-out date, the number of rooms, the number of adults, and the number of children. The view 92 also includes a “search” button 96. The event host enters at least required data in the fields 94 and then selects the “search” button 96.

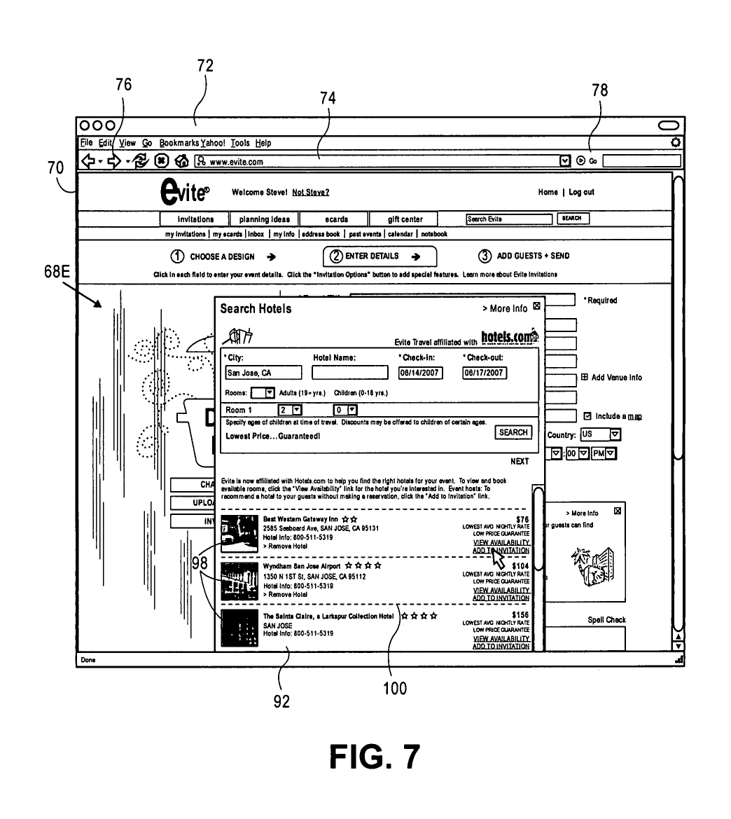

FIG. 7 shows a view 68E that appears after the event host selects the search button 96 in the view 68D of FIG. 6. The view 68E of FIG. 7 is the same as the view 68D of FIG. 6, except that the overlay window 92 includes a plurality of suggested hotels 98. The suggested hotels 98 are extracted at the affiliate site from a database of hotels and using criteria that match the data entered into the fields 94. The suggested hotels 98 are listed below one another and are separated from one another by dotted lines 100.

Each one of the suggested hotels includes the name of the hotel, a picture of the hotel, a link to check availability, and, of significance according to one aspect of the invention, a link to add the hotel to, and therefore associate the hotel with, the particular invitation (“ADD TO INVITATION”).

The event host can position the cursor on the link to add a particular hotel of the suggested hotels 98 to the particular invitation. The event host can also add more than one of the suggested hotels 98 to the invitation. In the present example, the event host selects only the first and second one of the suggested hotels 98.

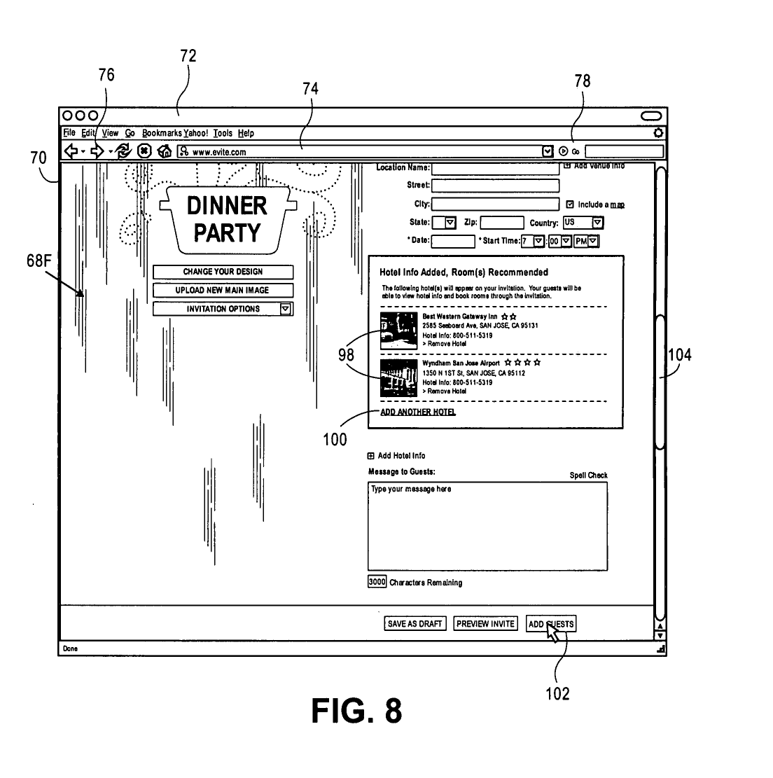

FIG. 8 shows a view 68F that appears after the user selects the second one of the suggested hotels 98 in the view 68E of FIG. 7. A similar view to the view 68F appears after the event host selects the first hotel of the suggested hotels 98 in the view 68E of FIG. 7. The view 68F of FIG. 8 is similar to the view 68E of FIG. 7, except that the overlay window 92 has been removed, and the view 68F of FIG. 8 is thus similar to the view 68C of FIG. 5. The main difference between the view 68F of FIG. 8 and the view 68C of FIG. 5 is that the two hotels, and only the two hotels, that have been selected by the event host in the view 68E of FIG. 7 are shown in the view 68F of FIG. 8. The view 68F also includes a link 101 to add another hotel. Should the event host select the link 101, a view similar to the view 68E will again appear, which will allow the event host to select an additional hotel to be added to the view 68F of FIG. 8. The hotels 98 are thus added to, and therefore associated with, the invitation represented by the view 68F of FIG. 8. The two hotels 98 selected by the event host are not associated with any other invitations. For example, the two hotels 98 in the view 68F of FIG. 8 are not associated with any invitations forming part of the event 80 shown in the view 98A of FIG. 3 because of the selection of the hotels 98 as discussed with reference to the invitation shown in the view 68E and 68F of FIGS. 7 and 8. It should, however, be understood that the same hotels 98 selected by the event host may be separately associated with the other event 80 shown in the view 68A of FIG. 3.

The view 68F also has a button 102 to add guests. The button 102 will also appear in the view 68C of FIG. 5 by selecting and dragging a vertical scroll bar 104 down.

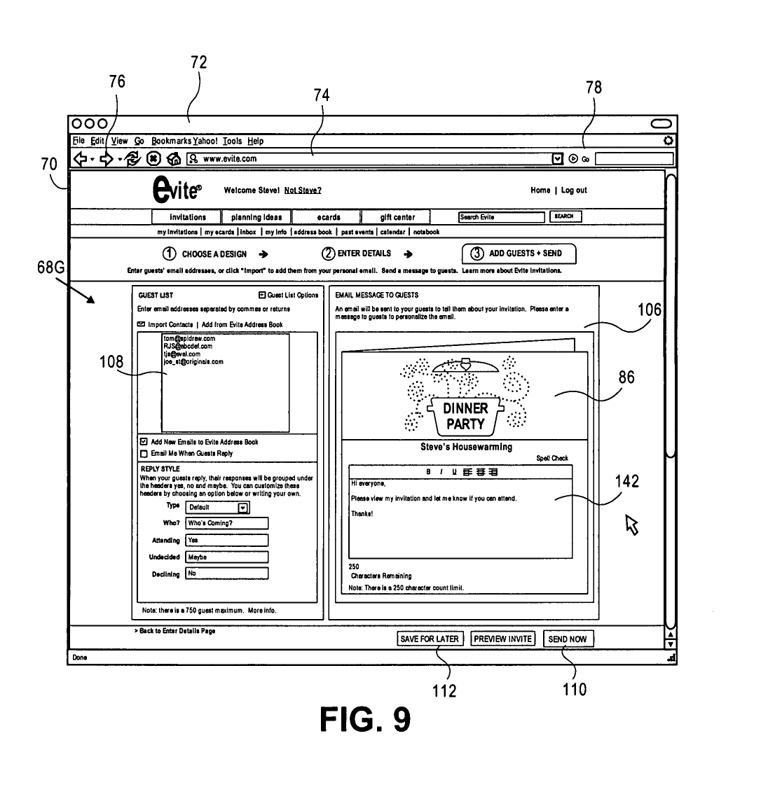

FIG. 9 shows a view 68G that appears after the event host selects the button 102 in the view 68F of FIG. 8. The view 68G includes a representation 106 of an invitation associated with the particular event and a guest list 108. The event host can enter email addresses of guests in the guest list 108.

The view 68G also includes a “send” button 110 and a “save” button 112. The event host can elect to select the “save” button 112, in which case no invitations will be sent, but the event and the associated invitation will be saved in the event server database 52 of FIG. 2. If the event host selects the “send” button 110, the event and the associated invitation will be saved in the event server database 52 of FIG. 2 and invitations will be sent over the Internet 42B to guest user computer systems 48A, 48B, and 48C in FIG. 1. The particular guest user computer systems 48A, 48B, and/or 48C depend on the email addresses entered in the guest list 108 in the view 68G of FIG. 9.

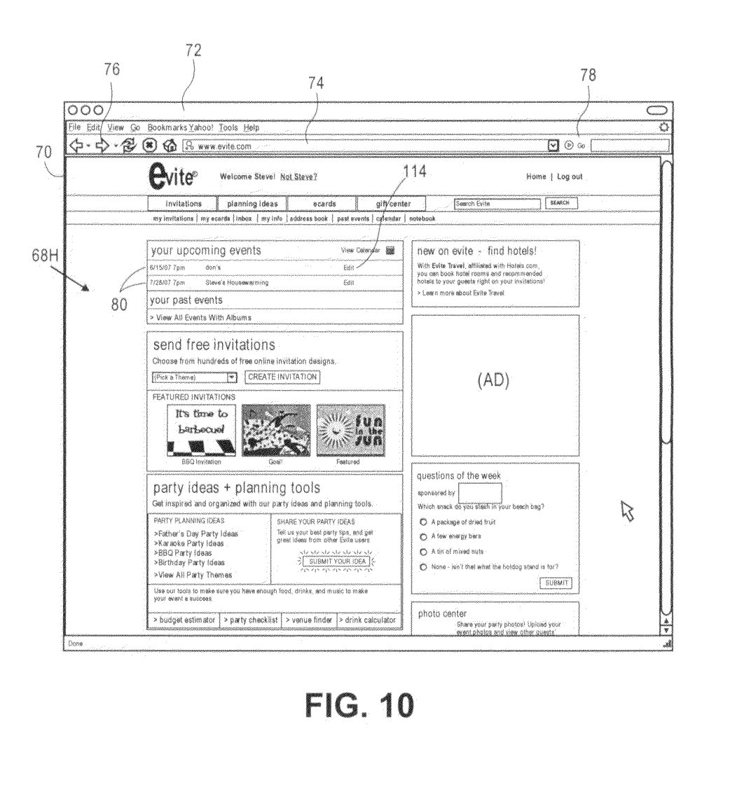

FIG. 10 is a view 68H that appears after the event host selects either the “send” button 110 or the “save” 112 in the view 68G of FIG. 9. The view 68H of FIG. 10 is the same as the view 68A of FIG. 3, except that the event that has been created, as described with reference to FIGS. 4 to 9, is added to the events 80. The event host can view and/or modify either one of the events 80 by selecting an “edit” link 114 next to a respective one of the events 80. In the present example, the event host selects the “edit” link 114 next to the event 80 that is created as described with reference to FIGS. 3 to 9, namely “Steve's housewarming.”

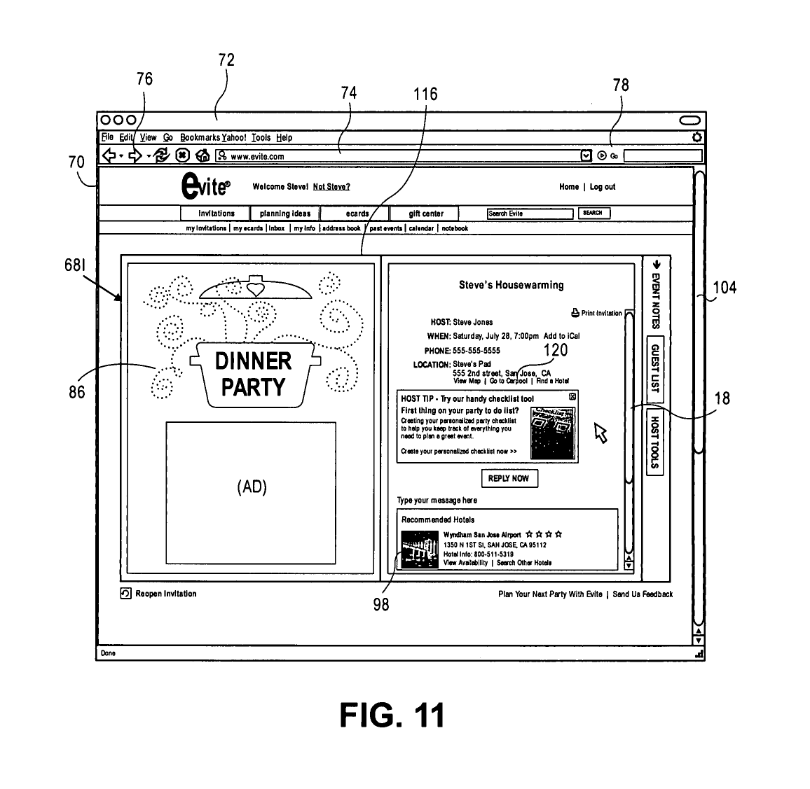

FIG. 11 shows a view 68I that subsequently appears. The view 68I shows an invitation 116 on the event host computer system 46 in FIG. 1 that is similar to invitations that will be viewed on the guest user computer systems 48A, 48B, and 48C. The invitation 116 includes a design 86 that is selected among the designs 86 in the view 68B of FIG. 4. The invitation also includes details that are entered in the view 68C of FIG. 5. The invitation 116 also includes the two hotels 98 shown in the view 68F of FIG. 8 (a vertical scroll bar 118 may have to be selected and dragged in order to show both hotels of the view 68I).

It will be understood that the hotels 98 are associated with the event using the locations module 64 in FIG. 2. The hotels 98 are also extracted at the affiliate site due to communications between the locations module 64 and the remote site.

The view 68I further includes a carpool link 120 (“go to Carpool”). The event host, in the present example, positions the cursor on and selects the carpool link 120.

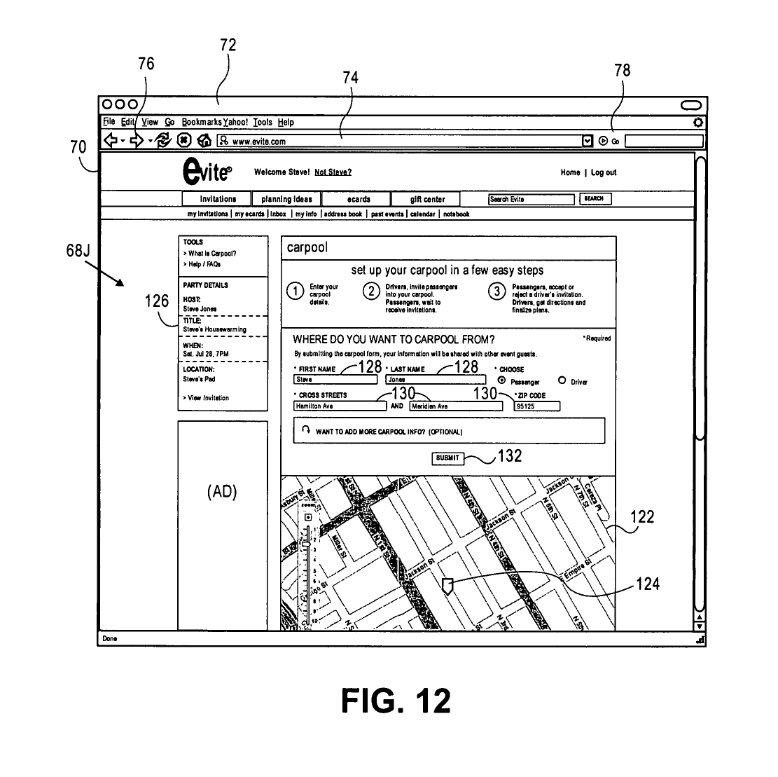

FIG. 12 shows a view 68J that appears after the event host selects the carpool link 120 in the view 68I of FIG. 11. The view 68J includes a map 122 with location marker 124 on the map 122. The location marker 124 is placed on the map 122 at an address corresponding to the address that is entered in the fields 88 of the view 68C of FIG. 5. The view 68J has a title 126 that also appears, for example, in the view 68I of FIG. 11 and as one of the events 80 in the view 68H of FIG. 10. The view 68J is thus associated with the remainder of the event because of a link to the view 68J, the position of the location marker 124, and the title 126.

The view 68J also includes fields 128 for entering a name and fields 130 for entering an address, including two cross streets and a zip code. The address represents a location where a person will be leaving from to the event represented by the location marker 124. The view 68J also includes a “submit” button 132. The event host positions the cursor and selects the “submit” button 132.

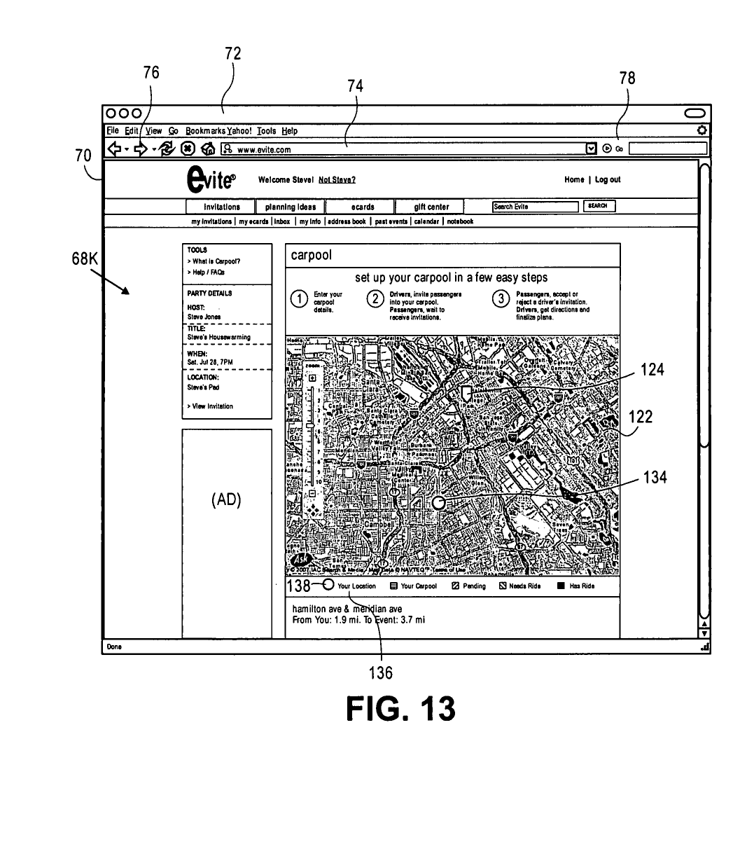

FIG. 13 shows a view 68K that appears after the event host selects the “submit” button 132 in the view 68J of FIG. 12. The view 68K includes the map 122, which is zoomed out relative to the map 122 in the view 68J of FIG. 12. The view 68K also includes the location marker 124 of the event. The view 68K further includes a new location marker 134 at the address entered in the fields 130 of the view 68J of FIG. 12. Legends 136 are located below the map 122 for “Your Location,” “Your Carpool,” “Pending,” “Needs Ride,” and “Has Ride.” Each one of the legends 136 has respective symbol 138 to the left thereof. The symbols 138 all differ from one another. The symbol 138 next to “Your Location” has the same shape and dimensions as the location marker 134.

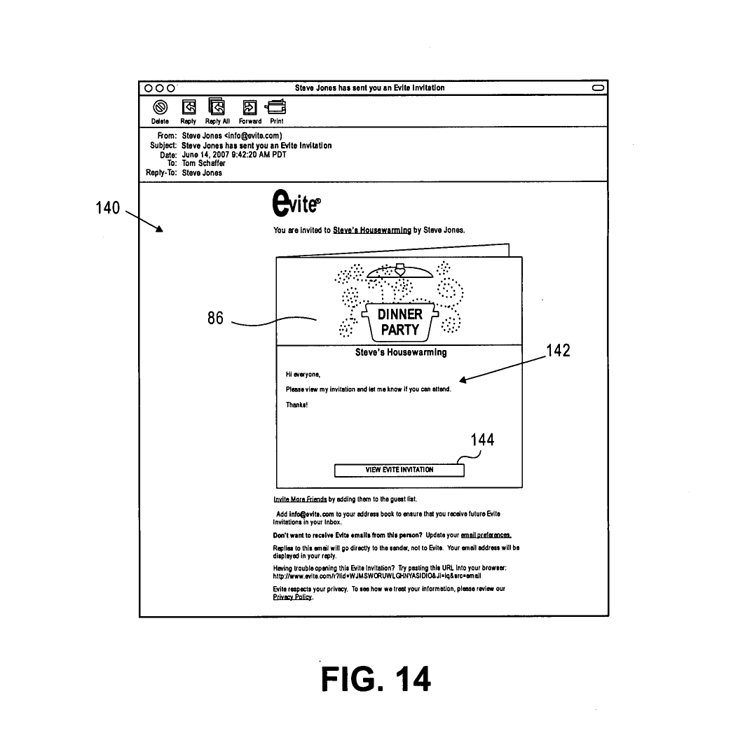

FIG. 14 shows an email 140 that is received by and displayed on a display of one of the guest user computer systems 48A in FIG. 1. The email 140 is transmitted from the event server computer system 44 over the Internet 42B to the guest user computer system 48A when the event host selects the “send” button 110 in the view 68G of FIG. 9. The email 140 includes the design 86 and a message 142 also shown in the view 68G of FIG. 9. The email 140 also includes a link 144 for directing the browser to the invitation (“VIEW EVITE INVITATION”). An guest of the guest user computer system 48A positions a cursor on and selects the link 144.

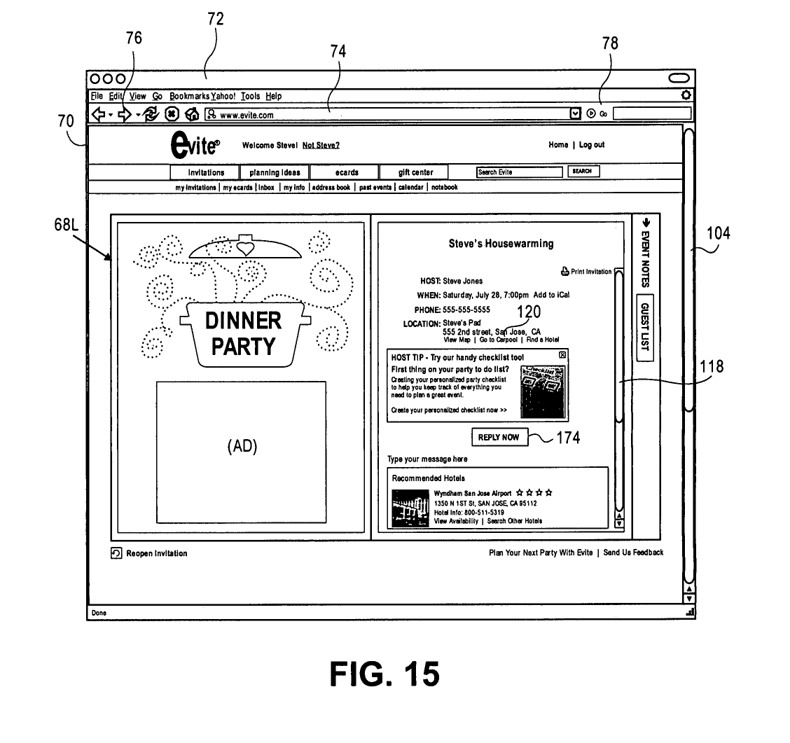

FIG. 15 shows a view 68L of the interface 54 in FIG. 2 that is displayed in a browser 172 of the guest user computer system 48A. The browser 172 is similar to the browser 72 described with reference to FIG. 3. The view 68L is similar to the view 68I shown in FIG. 11 and like reference numerals indicate like components. The view 68L includes a “reply” button 174 (“REPLY NOW”). The guest positions the cursor on and selects the reply button 174.

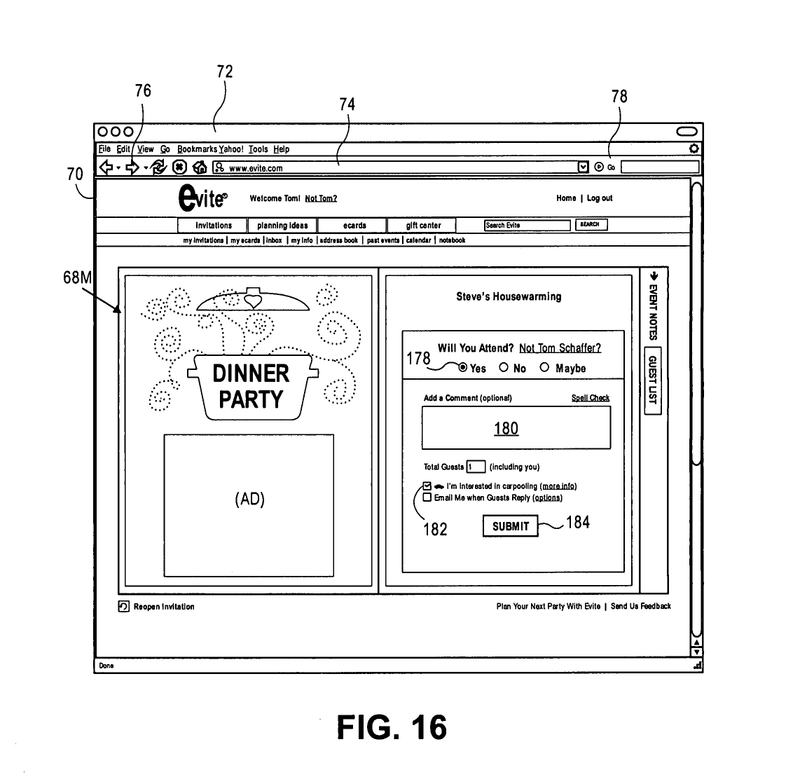

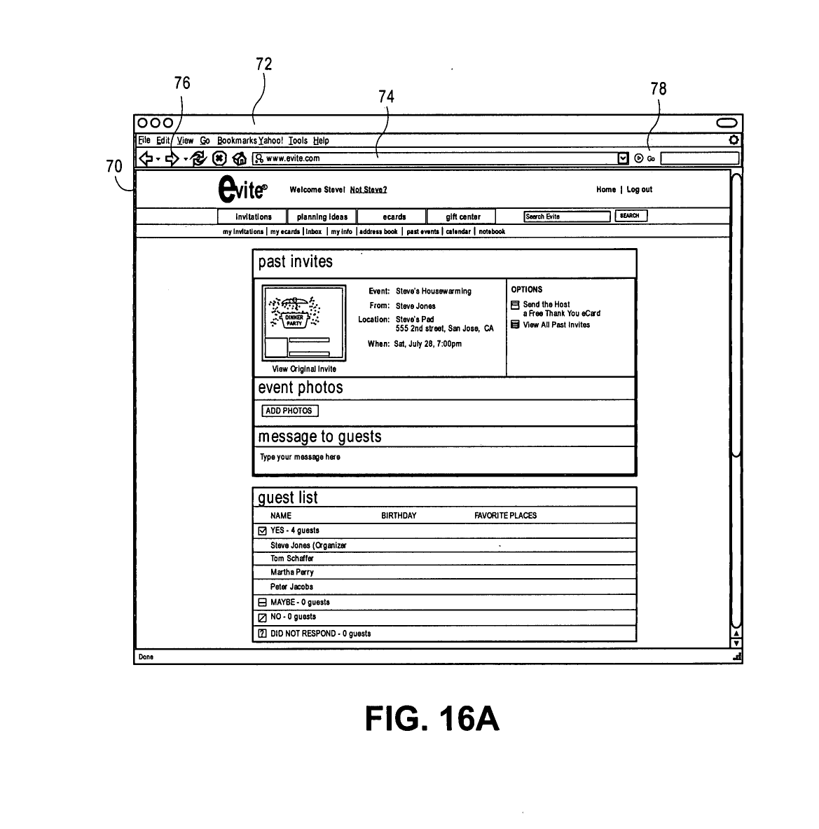

FIG. 16 shows a view 68M that is displayed on the guest user computer system 48A of FIG. 1 after the guest selects the “reply” button 174 in the view 68L of FIG. 15. The view 68M includes alternate selections 178 for “attending,” “not attending,” or “may be attending” the event. The view 68M also includes a text box 180 for adding a comment. The view 68M also includes a box 182 for selecting whether the guest is interested in carpooling.

Referring again to FIG. 15, the guest, instead of immediately selecting the “reply” button 174, may select one of the suggested hotels 98. The suggested hotels, in the view 68L of FIG. 15, are the same hotels 98 and only the hotels 98 shown in the view 68F of FIG. 8. Selection of one of the suggested hotels 98 will allow the guest to make a reservation at the selected hotel if rooms are still available.

The view 68M of FIG. 16 also includes a “submit” button 184. The guest positions the cursor on and selects the “submit” button 184.

FIG. 16A shows an event management page where responses from all guests are shown. The event management page is viewable by the host and all guests at their respective computers and is stored on the event server computer system 44 in FIG. 1.

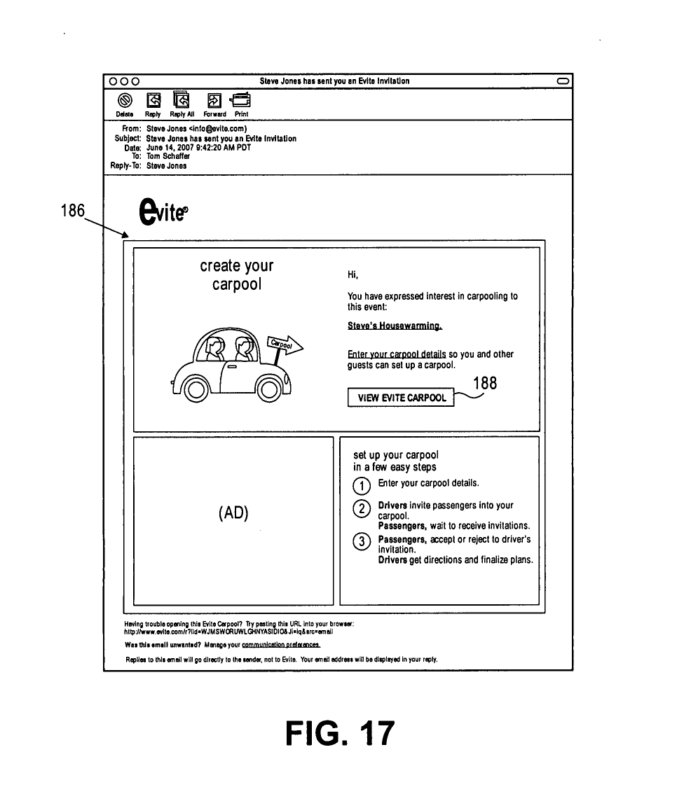

FIG. 17 shows an email 186 that is transmitted from the event server computer system 44 in FIG. 1 over the Internet 42B to the guest user computer system 48A, when the guest selects the “submit” button 184 in the view 68M of FIG. 16. The email 186 is only sent by the event server computer system 44 of FIG. 1 if the guest has selected the box 182 in the view 68M of FIG. 16; the guest does not receive the email 186 if the guest leaves the box 182 unchecked. The email 186 states that it is received because the guest has expressed an interest in carpooling and includes a link 188 (“VIEW EVITE CARPOOL”) that will direct a browser to a carpool view. The guest positions the cursor on and selects the link 188.

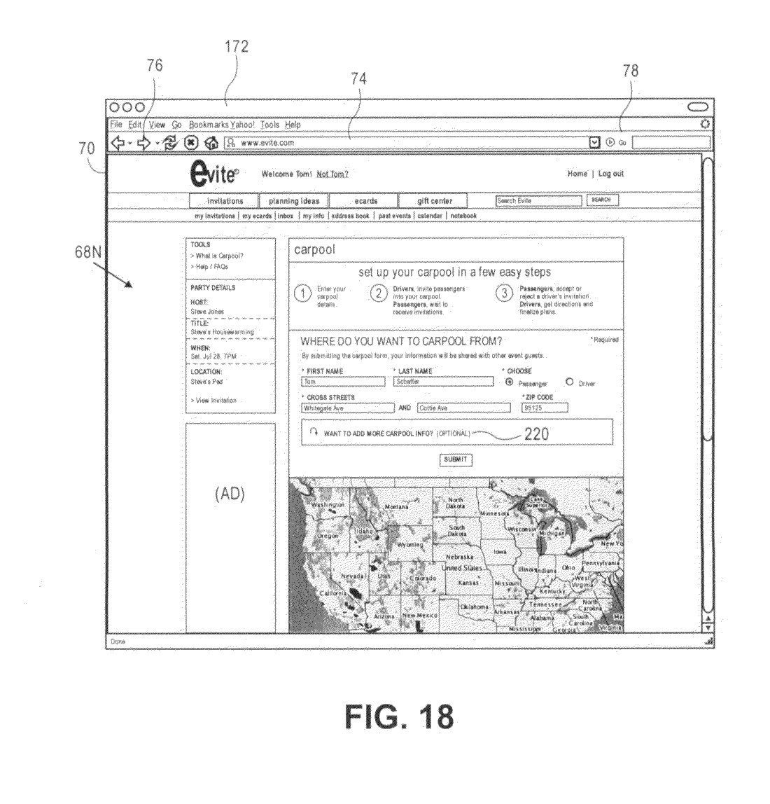

FIG. 18 is a view 68N that is appears in the browser 172 after the guest selects the link 188 in the email 186 of FIG. 17. The view 68N displayed in the browser 172 in FIG. 18 is similar to the view 68J displayed in the browser 72 of FIG. 12 (except that the map 122 is different in the two views) and like reference numerals indicate like components. The guest enters first and last names and an address in the fields 128 and 130 of the view 68N and then selects a “submit” button 132 of the view 68N.

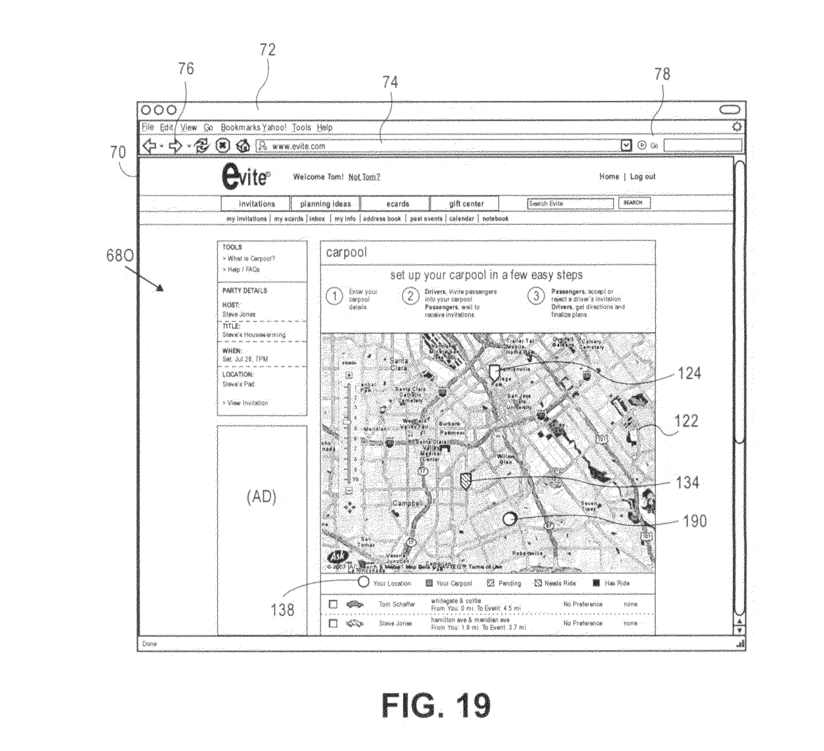

FIG. 19 shows a view 68O that appears after the guest selects the “submit” button 132 in the view 68N of FIG. 18. The view 68O of FIG. 19 is similar to the view 68K of FIG. 13, except that the location marker 134 corresponding to the address of the event host has a different shape and color. The location marker 190 is positioned on the map at a location corresponding to the address of the guest entered in the view 68N of FIG. 18. Color is represented by different types of crosshatching, solid, or blank location markers 124, 134, and 190 and corresponding symbols 138.

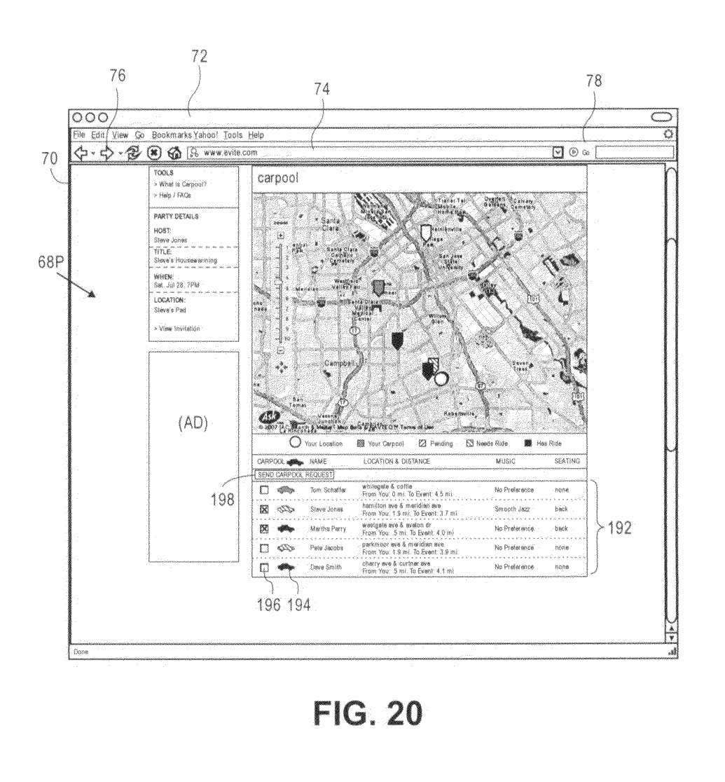

Further guests at the guest user computer systems 48B, 48C, etc., in FIG. 1 can similarly enter addresses on respective views similar to the view 68N of FIG. 18 upon receiving emails such as the email 186 of FIG. 17. FIG. 20 shows a further view 68P that will be displayed on any one of the computer systems 46, 48A, 48B, 48C, etc., in FIG. 1 as carpool data is collected from more of the computer systems 46, 48A, 48B, 48C, etc. The data entered in the view 68J of FIG. 12 and respective views, such as the view 68N of FIG. 18, is also displayed in a data area 192 of the view 68P in FIG. 20. Each one of the guests and the event host also has a respective identifier 194 in the data area 192, and the colors of the identifiers 194 are the same as the colors of the location markers 124, 134, and 190.

The view 68P also has a plurality of participant selectors 196. Each participant selector 196 is located adjacent to each one of the identifiers 194 of the guests/carpoolers. The guest at the guest user computer system 48A in FIG. 1 can send a carpool request to one or more of the guests at the guest user computer systems 48B, 48C, etc., or to the event host at the event host computer system 46 by selecting one or more of the participant selectors 196. Similarly, the event host at the event host computer system 46 can send carpool requests to any one of the guests at the guest user computer systems 46A, 46B, 46C, etc., by selecting participant selectors similar to the participant selectors 196C in the view 68P. In the present example, the guest selects the second and third participant selectors 196, corresponding to the event host and another guest. The view 68P also includes a carpool request send button 198 (“SEND CARPOOL REQUEST”). The guest positions the cursor on and selects the carpool request send button 198. Upon selection of the carpool request send button 198, an email is sent to the participants that have been selected by selecting the relevant participant selectors 196.

The email that is generated after the guest at the guest user computer system 48A in FIG. 1 selects the carpool request send button 198 in the view 68P of FIG. 20 is received by the event host computer system 46 and, for example, the guest user computer system 48B. The email (not shown) includes a link that opens a browser and it directs the browser to carpool information.

For the purposes of further discussion, an example is provided wherein the event host at the event host computer system 46 receives the email and opens a browser.

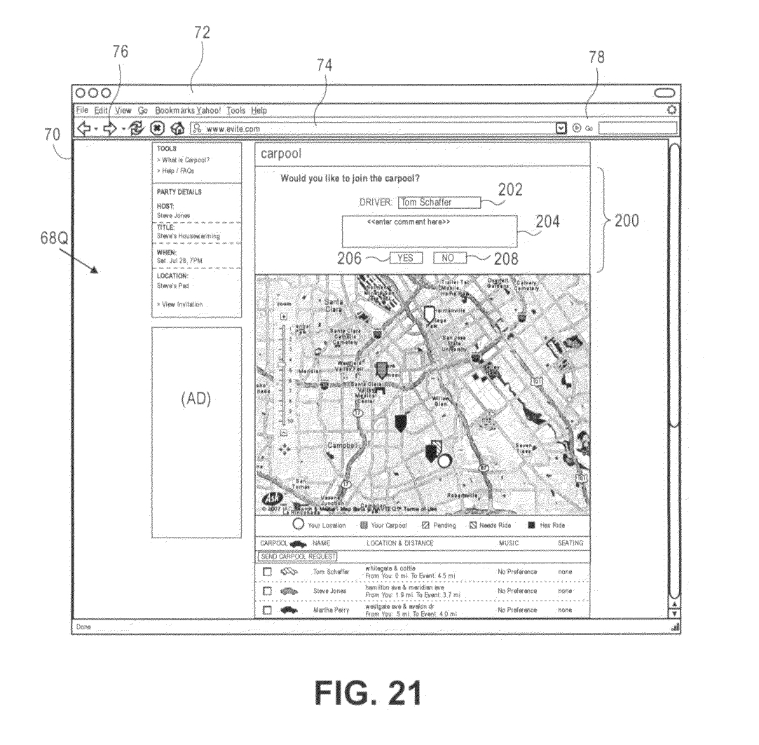

FIG. 21 shows a view 68Q in the browser 72 at the event host computer system 46 in FIG. 1. The view 68Q of FIG. 1 that is displayed in the browser 72 of the event host computer system 46 in FIG. 1 is similar to the view 68P of FIG. 20 that was displayed in the browser 172 of the guest user computer system 48A in FIG. 1, except that the view 68Q of FIG. 21 includes a communication section 200 above the map 122. The communication section 200 includes a field 202 for the name of the guest at the guest user computer system 48A, i.e., the participant/carpooler who has started the carpool. The communication section 200 further includes a comment field 204 and “yes” and “no” buttons 206 and 208 respectively. The event host can enter a comment in the comment field 204 and then either select the “yes” button 206 or the “no” button 208. If the event host selects the “yes” button 206, and not the “no” button 208, the event host will join the carpool of the guest at the guest user computer system 48A in FIG. 1. The color of the identifier 194 in the view 68Q corresponding to the guest at the guest user computer system 48A will then become the same as the color of the identifier 194 of the event host, and the colors of the location markers 124, 134, etc., will change accordingly. Carpool views on the displays of all the computer systems 46, 48A, 48B, 48C, etc., will continually be updated as carpools are created, expanded, or contracted.

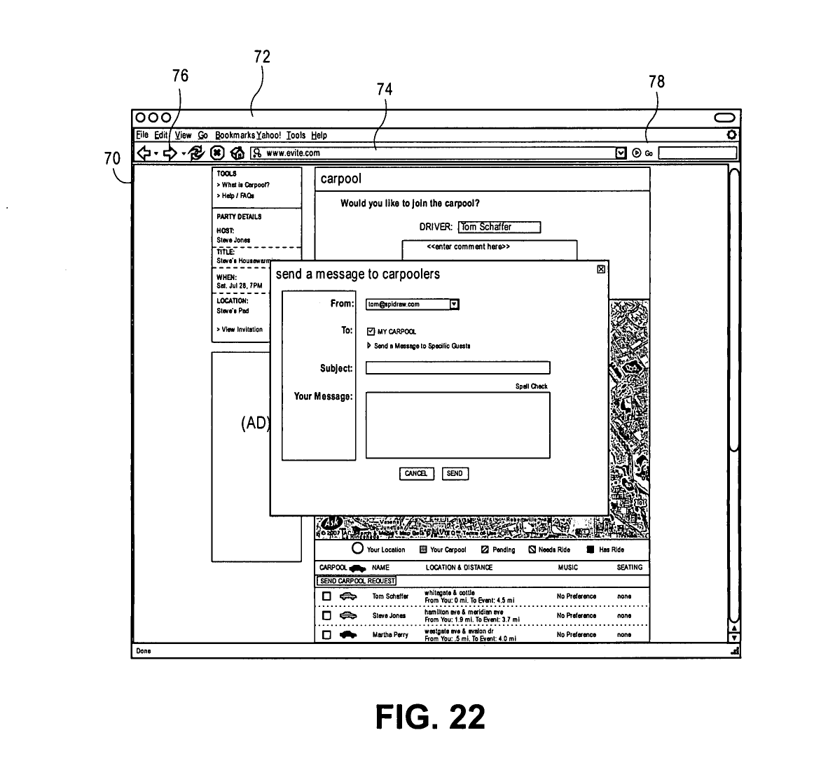

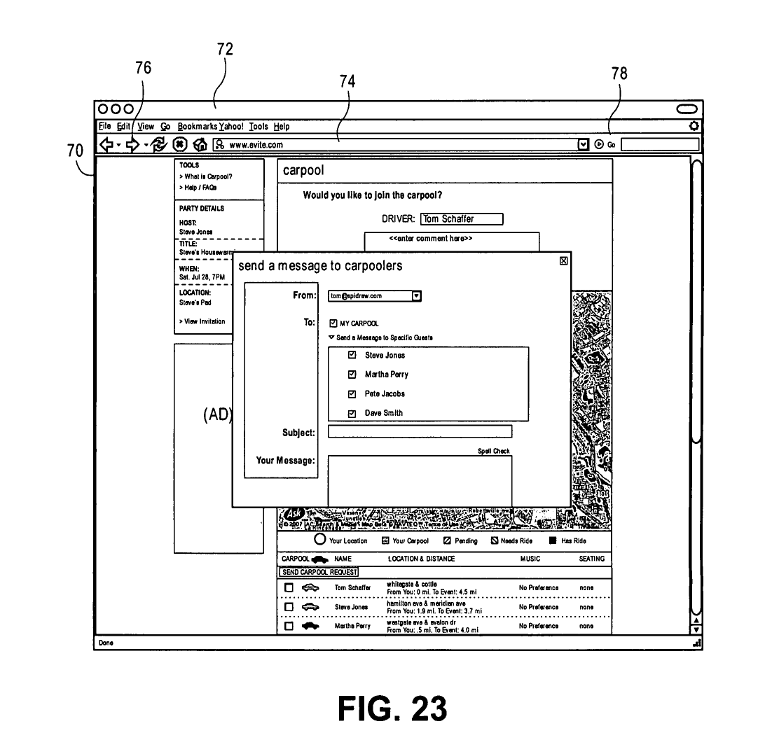

As an event approaches, participants of a carpool may want to communicate with one another to make final arrangements. FIGS. 22 and 23 illustrate how messages can be sent to members of a carpool, i.e., a subset of all the guests, or to a subset of the members of the carpool.

It will be understood that the carpool module 66 in FIG. 2 is primarily responsible for collecting carpool information as described with reference to FIGS. 1 to 20. The carpool module 66 is also primarily responsible for communications between participants/carpoolers as described with reference to FIGS. 20 to 23.

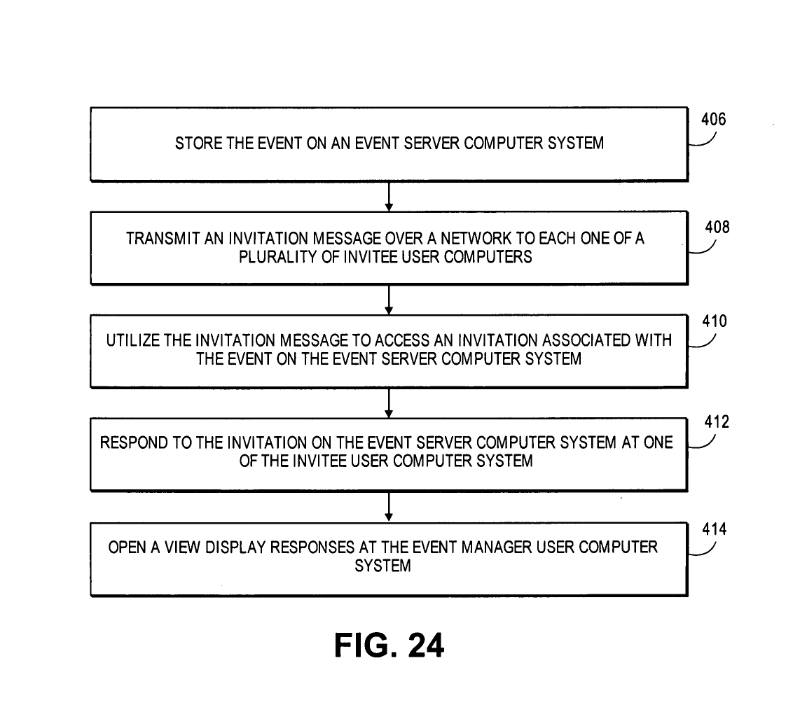

FIG. 24 illustrates generally how events are created using the system shown in FIGS. 1 and 2. At step 406, an event is stored at an event server computer system 44 in FIG. 1 (see FIG. 8). At step 408, an invitation message (FIG. 14) is sent over a network to each one of a plurality of guest user computer systems (FIG. 1). At step 410, the invitation message is utilized to access an invitation associated with the event on the event server computer system (FIG. 15). At step 412, an guest responds to the invitation on the event server computer system (FIG. 16) at one of the guest user computer systems (FIG. 1). At step 414, an event host at an event host user computer system can open a view to display responses (the view is displayed when the event host selects the relevant event 80 in the view 68H of FIG. 10).

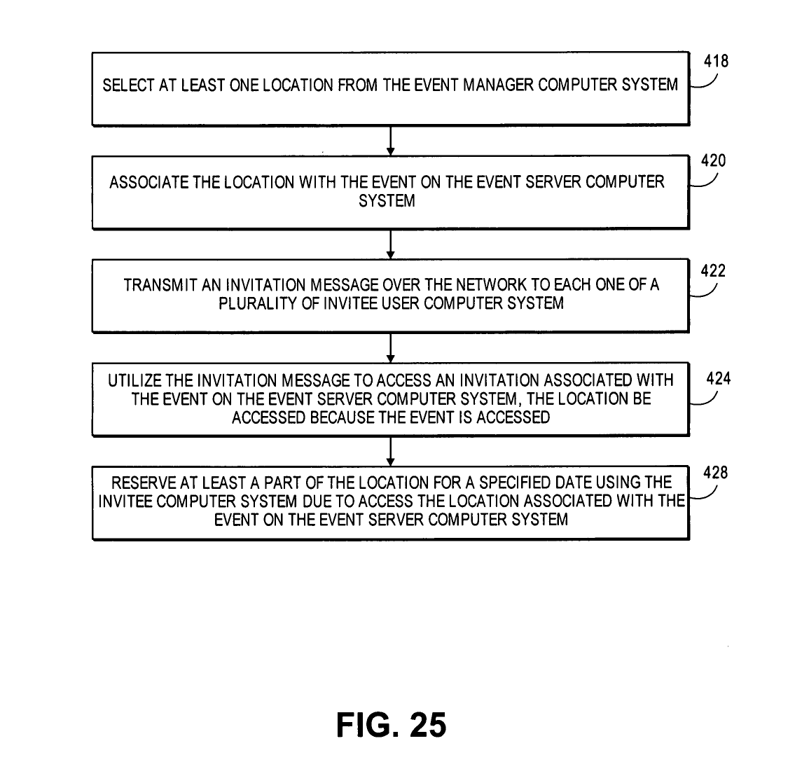

FIG. 25 displays in particular the functioning of the locations module 64 in FIG. 2. At step 418, an event host selects at least one location from a plurality of locations (FIG. 7) on an event host computer system (FIG. 1). At step 420, the event host associates the location with the event on the event server computer system (FIG. 8; FIG. 11).

At step 422, an invitation message (FIG. 14) is transmitted over the network to each one of a plurality of guest user computer systems (FIG. 1). At step 424, each guest utilizes the invitation message to access an invitation (FIG. 15) associated with the event on the event server computer system, the location being accessed because the event is accessed (FIG. 15). At step 428, an guest can reserve at least part of the location for a specified date (“view availability” in FIG. 15) using the guest user computer system (FIG. 1) due to access of the location associated with the event on the event server computer system (FIG. 15).

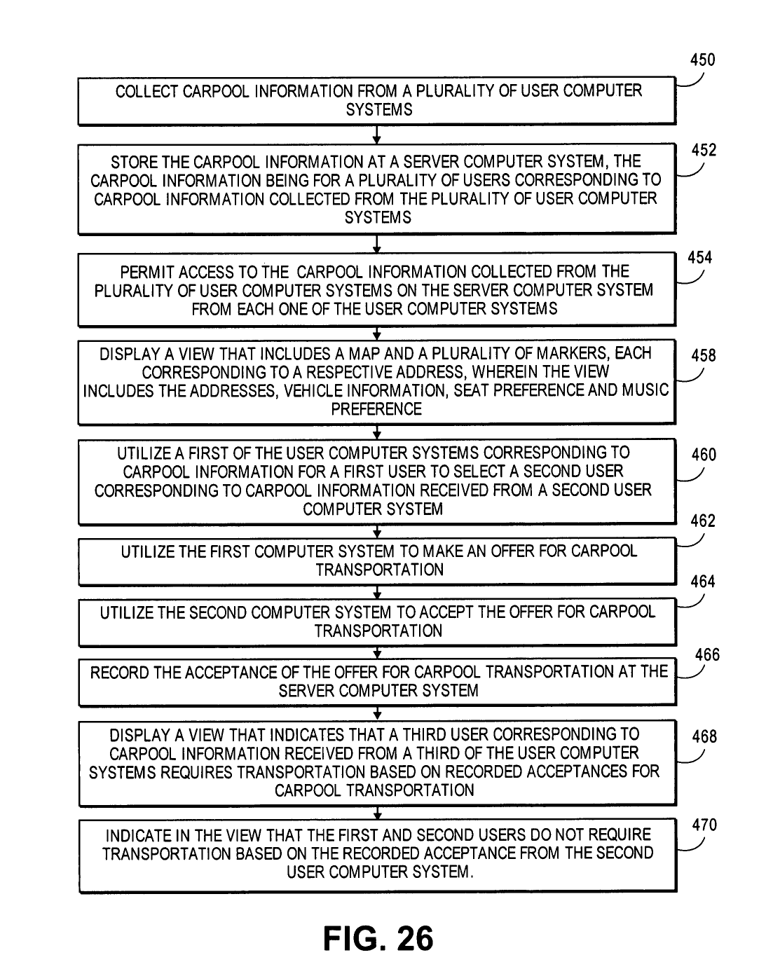

FIG. 26 illustrates how the carpool module 66 in FIG. 2 functions. At step 450, carpool information (FIG. 20) is collected from a plurality of user computer systems (FIG. 1, reference numerals 46, 48A, 48B, 48C). At step 452, the carpool information is stored at a server computer system (FIG. 2, reference numeral 52), the carpool information being for a plurality of users corresponding to carpool information collected from the plurality of user computer systems. At step 454, access is permitted to the carpool information collected from the plurality of user computer systems on the server computer system from each one of the user computer systems (FIG. 1). At step 458, a view is displayed that includes a map and a plurality of markers, each corresponding to a respective address, wherein the view includes the addresses, vehicle information, seat preference, and music preference (FIG. 20). Vehicle information, seat preference, and music preference can be added by selecting an additional information link 220 in the view 68N of FIG. 18. Selection of the additional information link 220 adds additional fields to the view 68N, the additional fields being for vehicle information, seat preference, and music preference.

At step 460, a user at a first of the user computer systems (e.g., the guest user computer system 48A in FIG. 1) selects a second user (FIG. 20) corresponding to carpool information received from a second user computer system (e.g., the event host computer system 46 in FIG. 1).

At step 462, the user at the first computer system makes an offer for carpool transportation (FIG. 20). At step 464, the user at the second computer system accepts the offer for carpool transportation (FIG. 21). At step 466, the acceptance of the offer for carpool transportation is recorded at the server computer system (FIG. 1, reference numeral 44; FIG. 2, reference numeral 52). At step 468, a view is displayed that indicates that a third user corresponding to carpool information received from a third user of the computer systems requires transportation based on recorded acceptances for carpool information (FIGS. 20 and 21). At step 470, the view indicates that the first and second users do not require transportation based on the recorded acceptance from the second user computer system (FIG. 21).

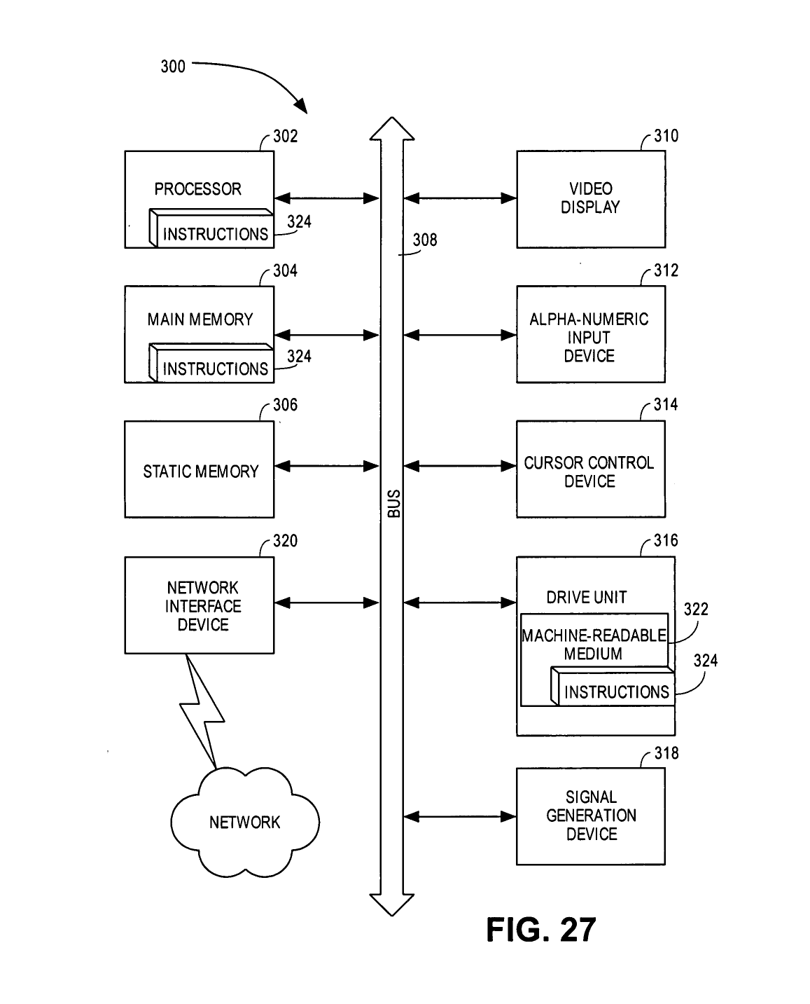

FIG. 27 shows a diagrammatic representation of a machine in the exemplary form of a computer 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary client computer 300 includes a processor 330 (e.g., a central processing unit (CPU), a graphics processing unit (GPU), or both), a main memory 332 (e.g., read-only memory (ROM), flash memory, dynamic random access memory (DRAM) such as synchronous DRAM (SDRAM) or Rambus DRAM (RDRAM), etc.), and a static memory 334 (e.g., flash memory, static random access memory (SRAM), etc.), which communicate with each other via a bus 336.

The client computer 300 may further include a video display 338 (e.g., a liquid crystal display (LCD) or a cathode ray tube (CRT)). The client computer 300 also includes an alpha-numeric input device 340 (e.g., a keyboard), a cursor control device 342 (e.g., a mouse), a disk drive unit 344, a signal generation device 346 (e.g., a speaker), and a network interface device 348.

The disk drive unit 344 includes a machine-readable medium 350 on which is stored one or more sets of instructions 352 (e.g., software) embodying any one or more of the methodologies or functions described herein. The software may also reside, completely or at least partially, within the main memory 332 and/or within the processor 330 during execution thereof by the client computer 300, the main memory 332 and the processor 330 also constituting machine-readable media. The software may further be transmitted or received over a network 354 via the network interface device 348.

While the machine-readable medium 350 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A communications system, comprising:
a receiving module for receiving the carpool information from a plurality of user computer systems over a network; and
a carpool module for collecting carpool information received by the receiving module from a plurality of user computer systems, storing the carpool information at a server computer system, the carpool information being for a plurality of users corresponding to carpool information collected from the plurality of user computer systems at a server computer system, and permitting access to the carpool information collected from the plurality of user computer systems on the server computer system from each one of the user computer systems, the carpool information being associated with the event.

2. The communications system of claim 1, further comprising:
an event server computer system;
an event creation module on the event server computer system for permitting the creation of an event from an event host computer system over the network; and
a storing module on the event server computer system for storing the event on the event server computer system.

3. The communications system of claim 2, further comprising:
a transmissions module on the event server computer system for transmitting an invitation message over the network to each one of a plurality of guest user computer systems.

4. The communications system of claim 3, wherein the invitation message is utilized to access an invitation associated with the event on the event server computer system, the carpool information being associated with the invitation.

5. The communications system of claim 4, further comprising:
a module on the event server computer system for receiving a response to the invitation on the event server computer system using one of the guest user computer systems.

6. The communications system of claim 5, further comprising:
a view displaying responses using the event host user computer system.

7. The communications system of claim 1, wherein the carpool information that is accessed from each one of the user computer systems includes an address.

8. The communications system of claim 7, further comprising:
a view that includes a map and a plurality of markers, each corresponding to a respective one of the addresses.

9. The communications system of claim 8, wherein the view includes the addresses.

10. The communications system of claim 1, wherein the carpool information that is accessed from each one of the user computer systems includes vehicle information.

11. The communications system of claim 1, wherein the carpool information that is accessed from each one of the user computer systems includes a seating preference.

12. The communications system of claim 1, wherein the carpool information that is accessed from each one of the user computer systems includes a music preference.

13. The communications system of claim 1, wherein the carpool module allows for utilizing a first of the user computer systems corresponding to a carpool information for a first user to select a second user corresponding to carpool information received from a second user computer system, and utilizing the first computer system to make an offer for carpool transportation.

14. The communications system of claim 13, wherein the carpool module allows for utilizing the second computer system to accept the offer for carpool transportation.

15. The communications system of claim 14, wherein the carpool module allows for recording the acceptance of the offer for carpool transportation at the server computer system.

16. The communications system of claim 15, further comprising:
a view that indicates that a third user corresponding to carpool information received from a third user of the user computer systems requires transportation based on recorded acceptances for carpool transportation.

17. The communications system of claim 16, wherein the view indicates that the first and second users do not require transportation based on the recorded acceptance from the second user computer system.

18. A communications method, comprising:
receiving carpool information over a network from a plurality of user computer systems;
collecting the carpool information received from the plurality of user computer systems;
storing the carpool information at a server computer system, the carpool information being for a plurality of users corresponding to carpool information collected from the plurality of user computer systems at a server computer system; and
permitting access to the carpool information collected from the plurality of user computer systems on the server computer system from each one of the user computer systems.

19. The method of claim 18, further comprising:
permitting the creation of an event from an event host computer system over the network; and
storing the event on an event server computer system, and associating the carpool information with the event.

20. The method of claim 19, further comprising:
transmitting an invitation message over the network to each one of a plurality of guest user computer systems.

21. The method of claim 20, further comprising:
associating the carpool information with an invitation; and
utilizing the invitation message to access the invitation associated with the event on the event server computer system.

22. The method of claim 21, further comprising:
responding to the invitation on the event server computer system using one of the guest user computer systems.

23. The method of claim 22, further comprising:
opening a view displaying responses using the event host user computer system.

24. The method of claim 18, opening a view displaying responses using the event host user computer system.

25. The method of claim 18, wherein the carpool information that is accessed from each one of the user computer systems includes an address.

26. The method of claim 25, further comprising:
displaying a view that includes a map and a plurality of markers, each corresponding to a respective one of the addresses.

27. The method of claim 26, wherein the view includes the addresses.

28. The method of claim 18, wherein the carpool information that is accessed from each one of the user computer systems includes vehicle information.

29. The method of claim 18, wherein the carpool information that is accessed from each one of the user computer systems includes a seating preference.

30. The method of claim 18, wherein the carpool information that is accessed from each one of the user computer systems includes a music preference.

31. The method of claim 18, further comprising:
utilizing a first of the user computer systems corresponding to a carpool information for a first user to select a second user corresponding to carpool information received from a second user computer system; and
utilizing the first computer system to make an offer for carpool transportation.

32. The method of claim 31, further comprising:
utilizing the second computer system to accept the offer for carpool transportation.

33. The method of claim 32, further comprising:
recording the acceptance of the offer for carpool transportation at the server computer system.

34. The method of claim 33, further comprising:
displaying a view that indicates that a third user corresponding to carpool information received from a third user of the user computer systems requires transportation based on recorded acceptances for carpool transportation.

35. The method of claim 34, further comprising:
indicating in the view that the first and second users do not require transportation based on the recorded acceptance from the second user computer system.

36. A computer-readable medium having stored thereon a set of instructions which, when executed by a computer, at least assist in carrying out a communications method, comprising:
receiving carpool information over a network from a plurality of user computer systems;
collecting the carpool information received from the plurality of user computer systems;
storing the carpool information at a server computer system, the carpool information being for a plurality of users corresponding to carpool information collected from the plurality of user computer systems at a server computer system; and
permitting access to the carpool information collected from the plurality of user computer systems on the server computer system from each one of the user computer systems.

37. The computer-readable medium of claim 36, the method further comprising:
permitting the creation of an event from an event host computer system over the network;
storing the event on an event server computer system; and
associating the carpool information with the event.

38. The computer-readable medium of claim 37, the method further comprising:
transmitting an invitation message over the network to each one of a plurality of guest user computer systems.

39. The computer-readable medium of claim 38, the method further comprising:
associating the carpool information with an invitation, wherein the invitation message is utilized to access an invitation associated with the event on the event server computer system.

40. The computer-readable medium of claim 39, the method further comprising:
responding to the invitation on the event server computer system using one of the guest user computer systems.

41. The computer-readable medium of claim 40, the method further comprising:
opening a view displaying responses using the event host user computer system.

42. The computer-readable medium of claim 36, wherein the carpool information that is accessed from each one of the user computer systems includes an address.

43. The computer-readable medium of claim 42, the method further comprising:
displaying a view that includes a map and a plurality of markers, each corresponding to a respective one of the addresses.

44. The computer-readable medium of claim 43, wherein the view includes the addresses.

45. The computer-readable medium of claim 36, wherein the carpool information that is accessed from each one of the user computer systems includes vehicle information.

46. The computer-readable medium of claim 36, wherein the carpool information that is accessed from each one of the user computer systems includes a seating preference.

47. The computer-readable medium of claim 36, wherein the carpool information that is accessed from each one of the user computer systems includes a music preference.

48. The computer-readable medium of claim 36, the method further comprising:
utilizing a first of the user computer systems corresponding to a carpool information for a first user to select a second user corresponding to carpool information received from a second user computer system; and
utilizing the first computer system to make an offer for carpool transportation.

49. The computer-readable medium of claim 48, the method further comprising:
utilizing the second computer system to accept the offer for carpool transportation.

50. The computer-readable medium of claim 49, the method further comprising:
recording the acceptance of the offer for carpool transportation at the server computer system.

51. The computer-readable medium of claim 50, the method further comprising:
displaying a view that indicates that a third user corresponding to carpool information received from a third user of the user computer systems requires transportation based on recorded acceptances for carpool transportation.

52. The computer-readable medium of claim 51, the method further comprising:
indicating in the view that the first and second users do not require transportation based on the recorded acceptance from the second user computer system.
